(19) United States
(12) Patent Application Publication
(10) Pub. No.: US 2004/0208413 A1
(43) Pub. Date: Oct. 21, 2004

(54) Cryogenic optical fibre temperature sensor

(76) Inventors: Walter Scandale, Geneva (CH); Massimo Facchini, Lausanne (CH); Lue Thevenaz, Yverdon-les-Bains (CH)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/477,476

(22) PCT Filed: May 13, 2002
(86) PCT No.: PCT/IB02/01630

(30) Foreign Application Priority Data
May 11, 2001 (GB) 0111623.5

(51) Int. Cl. G02B 6/00

(52) U.S. Cl. 385/12

(57) ABSTRACT

A sensor for sensing cryogenic temperatures, which includes an optical fiber (2) and a Brillouin spectral analyser (8) for measuring one or more temperature dependent Brillouin scattering parameters. Once the parameters are measured, they are used to determine the temperature.

The present invention relates to a temperature sensor. In particular, the present invention relates to an optical fibre temperature sensor for sensing cryogenic temperatures.

Many arrangements are known for sensing cryogenic temperatures, i.e. temperatures below 200K. One of the most common arrangements uses thermometers. For distributed systems, however, a plurality of such thermometers is needed and each has to be individually calibrated. This can be complex and so is disadvantageous.

Much effort has been made in recent years to overcome the imitations of standard thermometer based cryogenic temperature sensors. One solution is taught in U.S. Pat. No. 6,072,922. This discloses a cryogenic temperature sensor, which includes an optical fibre that has a permanent Bragg grating at a location along the length of the fibre. The grating is adapted to selectively alter portions of the signal carried by the fibre. In the region of the grating, the fibre is coated with a material that has a thermal expansion co-efficient that is larger than its own. The coating increases sensitivity to changes in temperature at or around the grating.

Whilst the sensor described in U.S. Pat. No. 6,072,922 goes some way to overcoming the disadvantages of prior arrangements, it suffers from the problem that standard and unprepared optical fibre cannot be used. Instead, the fibre used has to be specially adapted to include a grating and a coating. This increases the cost and complexity of the sensor.

An object of the present invention is to provide a cryogenic temperature sensor that is simple and relatively cheap.

According to one aspect of the present invention, there is provided a method for sensing temperature comprising:

measuring at least two temperature dependent Brillouin scattering parameters in an optical fibre and

using the two measured parameters to determine the temperature.

An advantage of this method is that it provides an accurate measure of the temperature, even at cryogenic levels, using preferably a standard optical fibre. This makes the process relatively cheap. Another advantage is that the system is easy to calibrate. A yet further advantage is that distributed temperature measurements can be readily made.

Preferably, the step of measuring the parameters occurs at a measuring location, and preferably, the optical fibre is coiled in the vicinity of the measuring location.

The at least two temperature dependent Brillouin scattering parameter may include the linewidth or half linewidth of the spectral distribution, the central frequency ν_{B} of the spectral distribution and maximal gain g_{B}. Preferably, the linewidth or half linewidth and the central frequency ν_{B} are used. Alternatively, any other combination could be used.

According to another aspect of the present invention, there is provided a sensor for sensing temperature comprising:

an optical fibre;

means for measuring at least two temperature dependent Brillouin scattering parameters, and

means for determining the temperature using the two measured parameters.

The at least two temperature dependent Brillouin scattering parameters may include the linewidth or half linewidth of the spectral distribution, the central frequency ν_{B} of the spectral distribution and maximal gain g_{B}. Preferably, the linewidth or half linewidth and the central frequency ν_{B} are used. Alternatively, any other combination could be used.

Preferably, the means for measuring at least two temperature dependent Brillouin scattering parameters comprise a Brillouin scattering analyser, for example the DiTeSt (OS-ST201) model, which is provided by OMNISENS S.A. of Lausanne, Switzerland

According to still another aspect of the present invention, there is provided a method for sensing cryogenic temperatures comprising:

measuring one or more temperature dependent Brillouin scattering parameters in an optical fibre, and

using at least one of the measured parameters to determine the cryogenic temperature.

The at least one temperature dependent Brillouin scattering parameters may include the linewidth or half linewidth of the spectral distribution, the central frequency ν_{B} of the spectral distribution and maximal gain g_{B}. Preferably, the linewidth or half linewidth and the central frequency ν_{B} are used. Alternatively, any other combination of parameters could be used.

According to yet another aspect of the present invention, there is provided a system for sensing cryogenic temperature comprising:

an optical fibre;

means for measuring one or more temperature dependent Brillouin scattering parameters in the optical fibre, and

means operable to use at least one of the measured parameters to determine the cryogenic temperature.

Various aspects of the invention will now be described by way of example only and with reference to the accompanying drawings, of which:

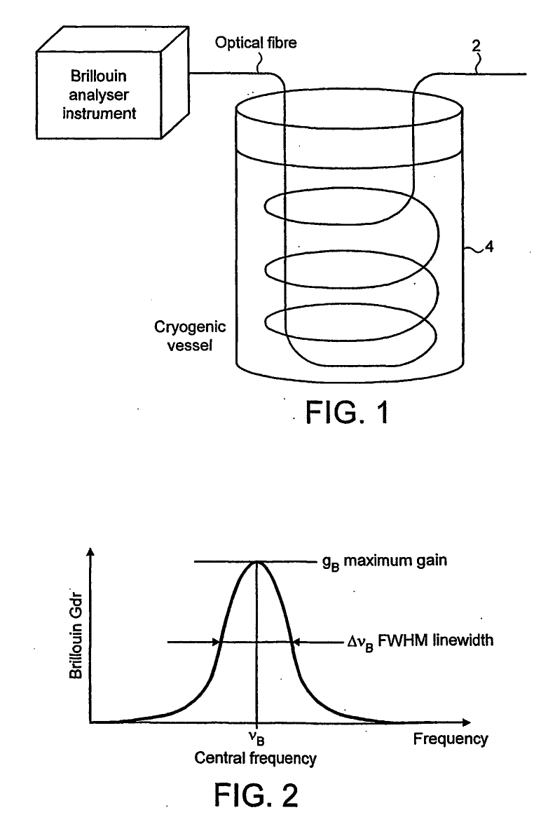

FIG. 1 is a schematic diagram of an arrangement for cryogenic temperature measurement,

FIG. 2 shows a typical spectral distribution for Brillouin scattered light;

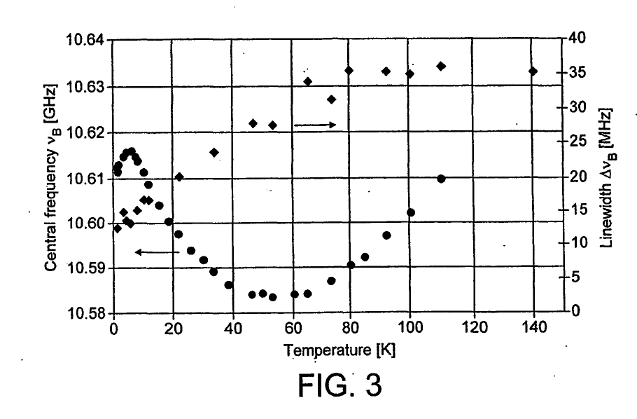

FIG. 3 shows a plot of the central frequency ν_{B} and linewidth for Brillouin scattered light, as a function of temperature;

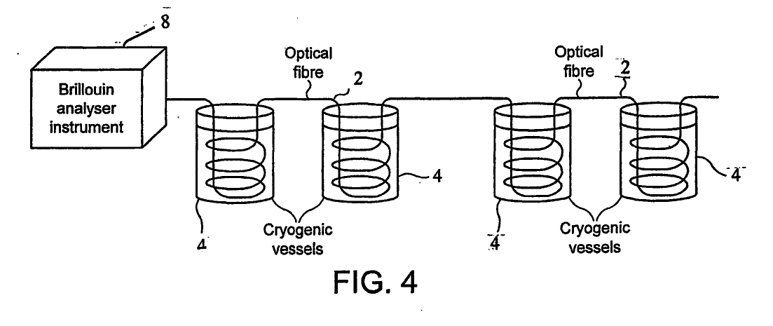

FIG. 4 is a schematic diagram of an arrangement for measuring cryogenic temperatures in a plurality of different vessels, using a single distributed fibre; and

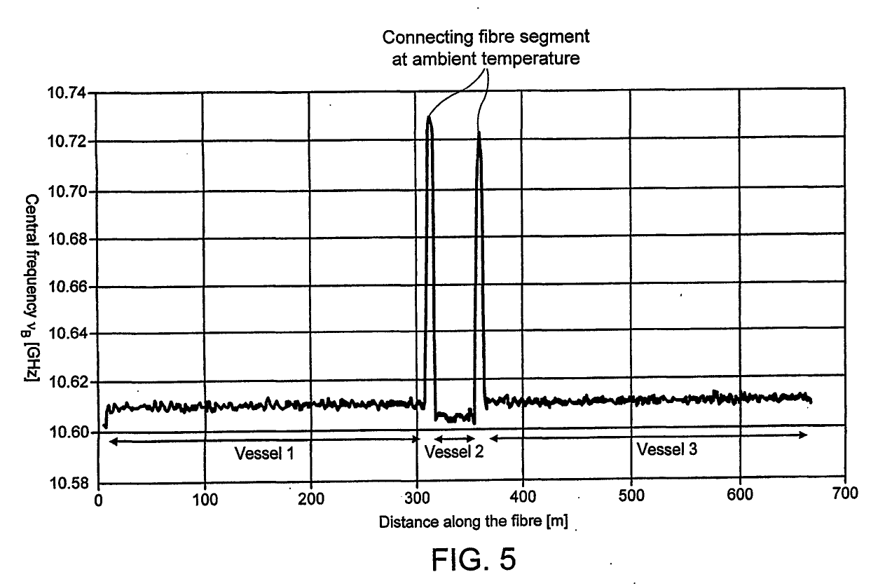

FIG. 5 is a plot of Brillouin central frequency shift as a function of distance along the length of a sensing fibre that is installed in three different cryogenic vessels.

FIG. 1 shows a sensor comprising an optical fibre 2, which fibre 2 is illustrated immersed in a cryogenic vessel 4. The fibre 2 is preferably a standard optical fibre, for example Corning SMF 28. The fibre 2 extends through the vessel 4 to a discrete area where the temperature is to be measured. Connected to one end of the fibre 2, externally of the cryogenic vessel 4, is a Brillouin spectral analyser 8 for measuring Brillouin scattering effects in the fibre. Brillouin spectral analysers 8 are known in the art and so will not be described herein in detail. Associated with the analyser 8 is a processor (not shown) for determining the temperature using measured Brillouin data. The temperature of the vessel 4 is determined using Brillouin scattering measurements. In order to measure Brillouin scattering effects, in one embodiment, two light waves are propagated through the fibre 2 in opposite directions, thereby to generate an acoustic wave, which interacts with the light. The result of this interaction transforms the optical signal, whereby the transformed signal carries quantitative information about the acoustic properties of the fibre, such as acoustic velocity and acoustic damping. These quantities depend on temperature and so provide a simple and accurate means for measuring temperature. Such a transformation of the light signal by an acoustic wave is called stimulated Brillouin scattering. It is well known that it is also possible to generate a Brillouin scattered signal using a single light wave and thermally generated acoustic waves. This is called spontaneous Brillouin scattering.

FIG. 2 shows an example of a typical spectral distribution of Brillouin scattered light. This is characterised by three parameters: central frequency ν_{B}, linewidth Δν_{B} and maximal gain g_{B}. These three parameters can be used individually or in combined pairs or all together to determine cryogenic temperature.

FIG. 3 shows a measurement of central frequency ν_{B} and linewidth Δν_{B} as a function of temperature. By correlating these two Brillouin parameters, an accurate measurement of temperature can be obtained over a broad temperature range. It should be noted that it is possible to use a single parameter to determine an accurate measure of cryogenic temperature over a restricted range, provided the restricted range is known. For example, in the plot of FIG. 3, if the Brillouin shift were measured as 10.6 GHz, this could mean that the temperature is in the region of, say, 20K or 100K. Assuming additional knowledge of the restricted temperature range, this ambiguity can be resolved, e.g. if it is known that the temperature is under 77K then the temperature would be determined as 20K. However, if the linewidth is simultaneously measured as 20 MHz, this provides a more accurate resolution of the ambiguity in the Brillouin shift measurements and indicates that the temperature is 20K. In this way, the accuracy of the technique in improved by using two Brillouin scattering parameters.

In use of the sensor of FIG. 1, the Brillouin scattering parameters are measured and used to determine the temperature of the vessel 4. As mentioned above the preferred parameters may be central frequency ν_{B} and linewidth Δν_{B}. Once the measurements are taken, the step of determining the temperature is typically done using the processor. This is programmed to compare the measured parameters with predetermined or calibrated measurements, thereby to determine the temperature.

The use of optical fibre 2 as described above makes distributed measurements possible, i.e. provides a measurement of temperature at discrete points along the length of the fibre. This is because Brillouin scattering parameters, in particular the shift in the Brillouin frequency, can be measured as a function of length along a fibre. This is well known. A typical plot of Brillouin shift frequency against distance along an optical fibre for a verifying temperature is shown in FIG. 5.

The ability to determine a temperature at a plurality of locations is advantageous and for certain applications means that a single optical cable can replace several thousand classical point probes.

FIG. 1 shows an arrangement in which the optical fibre 2 extends along a substantial part of the cryogenic vessel 4. This enables a distributed measurement of the temperature along the length of the fibre 2. FIG. 4 shows an arrangement in which the optical fibre 2 extends through a plurality of different cryogenic vessels 4. This enables a distributed measurement of the temperature across different vessels using a single fibre 2 and a single Brillouin scattering analyser 8. This is advantageous. As an example, FIG. 5 shows a plot of Brillouin central frequency shift as a function of distance along the length of a sensing fibre that is installed in three different cryogenic vessels. The peaks in this plot are indicative of temperature differences between the vessels and the laboratory ambient—the flat part in this plot can be used to determine the absolute temperature in each vessel.

By using at least two Brillouin scattering parameters as described above, it is possible to gain an accurate measure of cryogenic temperatures, whilst using preferably a standard optical fibre.

As shown in FIGS. 1 and 4, the optical fibre 2 is preferably coiled within the cryogenic vessel(s) 4, that is, in the vicinity of the measurement location(s), to enhance the sensitivity of the measurement.

A skilled person will appreciate that variations of the disclosed arrangements are possible without departing from the invention. Accordingly, the above description of a specific embodiment is made by way of example and not for the purposes of limitation. It will be clear to the skilled person that minor modifications can be made without significant changes to the operation described above.

1. A method for sensing cryogenic temperature comprising:
measuring one or more cryogenic temperature dependent Brillouin scattering parameters in an optical fibre and
using at least one of the measured parameters to determine the cryogenic temperature.

2. A method as claimed in claim 1, wherein the cryogenic temperature dependent Brillouin scattering parameter is any one or more of the linewidth or half linewidth of the spectral distribution, the central frequency ν_{B} of the spectral distribution and maximum gain g_{B}.

3. (Original) A method as claimed in claim 2, comprising using the linewidth or half linewidth and the maximum gain g_{B}.

4. A method as claimed in claim 2, comprising using the linewidth or half linewidth and the central frequency.

5. A method as claimed in claim 2, comprising using the maximum gain g_{B} and the central frequency.

6. A method as claimed in claim 2, comprising using the maximum gain g_{B}, the central frequency and the linewidth or half linewidth.

7. A method as claimed in claim 1, wherein the cryogenic temperature is in a range below 200K.

8. A cryogenic temperature sensor for sensing cryogenic temperature comprising:
an optical fibre;
means for measuring at a measuring location one or more cryogenic temperature dependent Brillouin scattering parameters in an optical fibre and
means for using at least one of the measured parameters to determine the cryogenic temperature.

9. A sensor as claimed in claim 8, wherein the cryogenic temperature dependent Brillouin scattering parameter is any one or more of the linewidth or half linewidth of the spectral distribution, the central frequency ν_{B} of the spectral distribution and maximum gain g_{B}.

10. A sensor as claimed in claim 9, wherein the means for using are operable to use the linewidth or half linewidth and the maximum gain g_{B}.

11. A sensor as claimed in claim 9, wherein the means for using are operable to use the linewidth or half linewidth and the central frequency.

12. A sensor as claimed in claim 9, wherein the means for using are operable to use the maximum gain g_{B} and the central frequency.

13. A sensor as claimed in claim 9, wherein the means for using are operable to use the maximum gain g_{B}, the central frequency and the linewidth or half linewidth.

14. A sensor as claimed in claim 8, wherein the cryogenic temperature is in a range below 200K.

15. A sensor as claimed in claim 8, comprising means for determining temperature as a function of length along the optical fibre.

16. A sensor as claimed in claim 8, wherein the means for measuring comprise a Brillouin scattering analyser.

17. A sensor as claimed in claim 8, wherein the optical fibre is coiled in the vicinity of the measuring location.

18. (Canceled)

19. (Canceled)
